(19) United States
(12) Patent Application Publication
(10) Pub. No.: US 2015/0113286 A1
(43) Pub. Date: Apr. 23, 2015

(54) METHOD AND SYSTEM FOR CHAIN TRANSFORMATION

(71) Applicants: Michael Wiener, Ottawa (CA); Phil Eisen, Ottawa (CA)

(72) Inventors: Michael Wiener, Ottawa (CA); Phil Eisen, Ottawa (CA)

(73) Assignee: IRDETO CANADA CORPORATION, Ottawa, ON (CA)

(21) Appl. No.: 14/386,667

(22) PCT Filed: Mar. 21, 2012
(86) PCT No.: PCT/CA2012/000251

§ 371 Date: Nov. 24, 2014

(51) Int. Cl. H04L 9/06

(52) U.S. Cl. CPC H04L 9/0637
USPC 713/189

(57) ABSTRACT

A method and system for secure data protection is provided. The method and system includes carrying out a transform on structured data comprising a fixed data field for implementing an application, the structured data having n segments, each having m bits, including: encoding each of the n segments subsequently to provide n coded segments, including: encoding each of the (n−1) segments depending on a previous segment value; and changing at least one of the n encodings to the n segments such that the fixed data field of a first structured data is encoded differently from the fixed data field of a second structured data, and the transformed first structure data and the transformed second structure data are further processed in the same operation for implementing the application.

### RELATED APPLICATION DATA

This application is the National Stage of International Patent Application No. PCT/CA2012/000251, filed Mar. 21, 2012, the disclosure of which is hereby incorporated by reference in its entirety.

### FIELD OF INVENTION

The present invention relates to secure data protection, more specifically to a method and system for chain transformation.

### BACKGROUND OF THE INVENTION

Secured software implementations often rely on transforms to protect data being processed by it. The transformations are used internal to the software application but also are applied to the external data interfaces. This means that other applications need to use the correct transform in order to send and receive data from the secured software implementation. A software transform generally is assumed to be an invertible function that converts the data into the transformed domain.

Secured software applications are assumed to operate under a so-called whitebox attack environment. This means that the attacker is assumed to have full control over the execution environment of the secured software application. This allows the attacker to observe and modify the data structures and the instruction sequences.

Digital Rights Management (DRM) clients are an example of such secured software implementations. The DRM client receives encrypted content and only decrypts the content according to usage rules that are encoded in licenses associated with the content. The license also may contain an encrypted version of a content encryption key (CEK) that is required to decrypt the protected content. The license processing in the DRM client is assumed to be secured.

The output of the decryption process requires further processing by a content decoder. In order to prevent an attacker from intercepting the input to the content decoder, a transform is generally applied to (parts of) the input(s) to the content decoder. If the transform is applied to the content stream, some secured software mechanisms are present in the content decoder application.

A wide range of transforms may be used to encode program variables. However, if the transform is too complex to allow a program to compute with the encoded data, then the program must remove the transform before making computations. This defeats the purpose of the transform. Commonly, transforms are very simple and are applied to individual bytes of program data. For example, a simple linear transform to represent a byte x as sx+b for constants s and b permits a program to perform certain computations without ever having to explicitly store the quantity x.

The input to the content decoder contains fields that are known to an attacker. Examples of known fields are header data. The problem with simple linear encodings is that fixed bytes (in a fixed position within a block) are always encoded to the same values. For example, if a linear encoding (sx+b) is applied to a block of data that always starts with two fixed bytes (0x00, Ox01), the encoded bytes would be (b, s+b). By monitoring the encoded bytes, an attacker starting with no knowledge of our encoding methods might eventually figure out (sx+b) encoding and learn to read the rest of the data in each block.

There is a need for a method and system for a transform that avoids the fixed-byte problem while keeping the transform simple enough that encoded data can still be computed on without having to remove the transform first.

### SUMMARY OF THE INVENTION

It is an object of the invention to provide a method and system that obviates or mitigates at least one of the disadvantages of existing systems.

According to an aspect of the present disclosure there is provided a method for secure data protection, which includes: carrying out a transform on structured data comprising a fixed data field for implementing an application, the structured data having n segments, each having m bits, including: encoding each of the n segments subsequently to provide n coded segments, including: encoding each of the (n−1) segments depending on a previous segment value; and changing at least one of the n encodings to the n segments such that the fixed data field of a first structured data is encoded differently from the fixed data field of a second structured data, and the transformed first structure data and the transformed second structure data are further processed in the same operation for implementing the application.

According to a further aspect of the present disclosure there is provided a computer readable storage medium storing computer instructions capable, when executed, of causing a system having a processor to perform the method.

According to a further aspect of the present disclosure there is provided a system for secure data protection, which includes: a processor; at least one computer-readable storage medium storing computer instructions translatable by the processor to perform at least one of the method.

### BRIEF DESCRIPTION OF THE DRAWINGS

These and other features of the invention will become more apparent from the following description in which reference is made to the appended drawings wherein:

FIG. 1 depicts in a schematic diagram an example of a chained transform module;

FIG. 2 depicts in a flow chart an example of the process of transforming uncoded data by the chained transform;

FIG. 3 depicts in a schematic diagram another example of the chained transform module;

FIG. 4 depicts in a flow chart an example of the process of transforming uncoded data by the chained transform shown in FIG. 3;

FIG. 5 depicts in a flow chart an example of the chained transform application;

FIG. 6 depicts in a flow chart another example of the chained transform application;

FIG. 7 depicts in a schematic diagram a further example of the chained transform;

FIG. 8 depicts in a schematic diagram the last set of tables for the last AES step together with the chained transform of FIG. 7;

FIG. 9 depicts in a schematic diagram an example of sub-AES operations;

FIG. 10 depicts in a schematic diagram an example of the last set of tables shown in FIG. 8 with the sub-AES operations shown in FIG. 9;

FIG. 11 depicts in a flow chart an example of selecting encodings for the operation of FIG. 10;

FIG. 12 depicts in a schematic diagram an example of the chained transform application; and

FIG. 13 depicts in a schematic diagram another example of the chained transform application.

### DETAILED DESCRIPTION

Embodiments of the present disclosure provide a chained transform method and system for transforming structured data having one or more fixed data fields such that the fixed data fields are not always encoded to the same values and the transformed data can still be computed on or transformed without removing the chained transform for implementing the application of the data. The fixed field is in a fixed position, which may be known to an attacker. One example of the fixed fields is header information. The structured data may be for example, but not limited to, video streams or RSA private keys. Applications that would use the chained transform to deal with the structured data include, for example, video stream encoding and loading dynamic RSA keys.

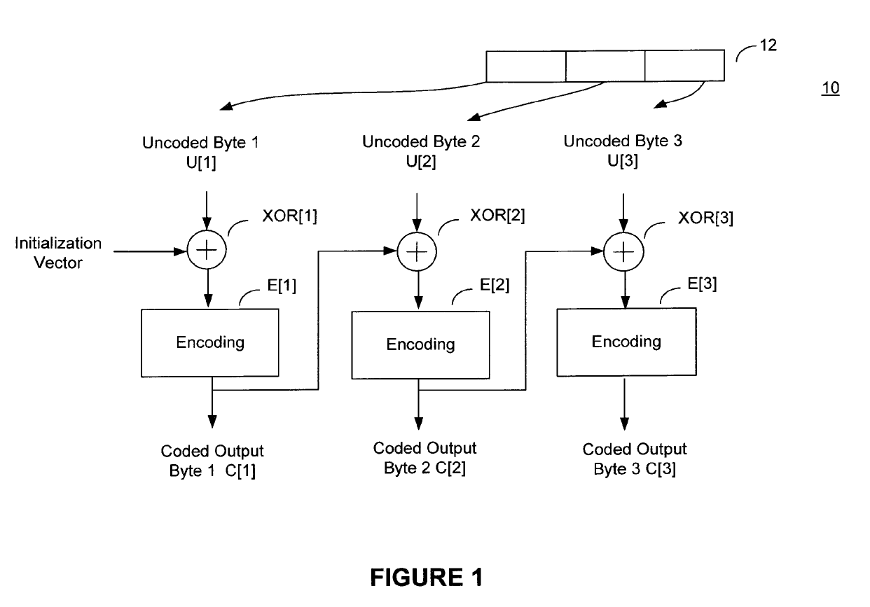

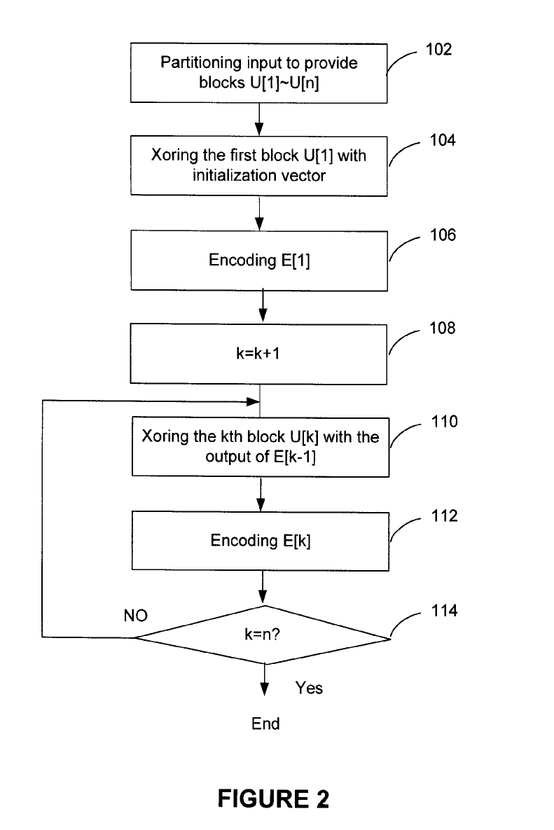

Referring to FIGS. 1 and 2, there is illustrated an example of the chained transform for the structured data. The chained transform 10 transforms uncoded input such that the encoding of a particular segment of the uncoded data depends on the encoded value on the previous segment of the uncoded data. If any segment before the current one changes, then the encoding the current segment will be different. Here each segment has m bits (m>0). In this example, the segment is a byte having 8 bits, and the chained transform 10 carries out encoding on a byte by byte basis. The first two bytes may be always fixed.

The chained transform 10 shown in FIGS. 1 and 2 includes xor and encoding steps. Uncoded input 12 is partitioned into n segments (or blocks) U[i] (i=1, 2, . . . , n) (102). The input 12 is any data requiring encoding that is structured, which may contain, for example, but not limited to, video content, RSA private key. In FIG. 1, three segments U[1], U[2] and U[3] (n=3) are shown for illustration purpose only. The first uncoded segment U[1] is xored XOR[1] with an initialization vector (104). The initialization vector is a random set of m bits. Then the output of XOR[1] is encoded by E[1] (106), which provides coded output byte C[1]. At this point k=1. The counter k is incremented (108). Each uncoded segment U[k] is xored XOR[k] with the result of encoding E[k−1] (110). E[k] encodes the output of xoring XOR[k] (112), which provides coded output byte C[k]. If k is less than n (114) (i.e., the last segment is not xored and encoded), the counter k is incremented (108) and then the xoring and encoding is implemented for the next segment (110, 112). Encoding E[k] is a bijection.

In this example, the initialization vector is a byte value that is included at the beginning of the output that serves as the initial “previous coded byte”. The initialization vector changes the encoding to the second segment. With the initialization vector the first encoded byte would no longer be a special case (i.e., the first byte does not have a single fixed encoding). Any time a sub-field, such as bytes 4 to 8 (n=8), is read, bytes 4 to 8 can be computed by reading encoded bytes 3 to 8.

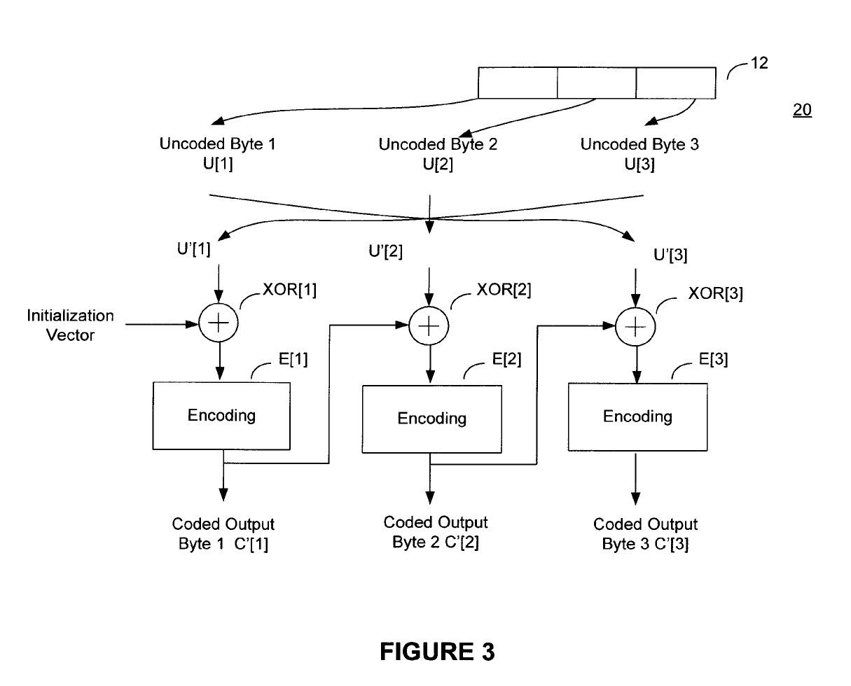

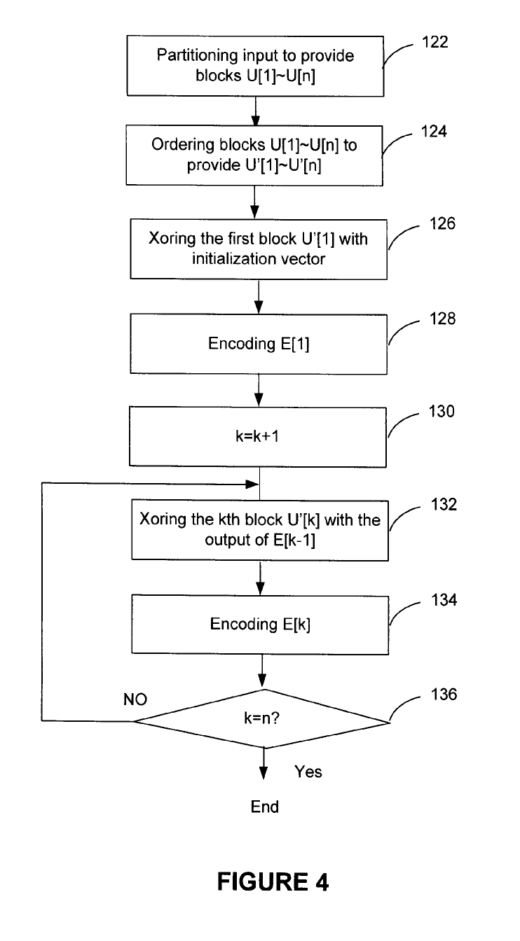

Referring to FIGS. 3 and 4, there is illustrated another example of the chained transform for the structured data. The chained transform 20 partitions the uncoded input 12 into n segments U[1], U[2], . . . , U[n] (122), and then changes the order of the n segments (124) to provide segments U′[1], . . . , U′[n]. The first uncoded segment U′[1] is xored XOR[1] with an initialization vector (126). The output of XOR[1] is encoded by E[1] (128), which provides coded output C′[1]. At this point k=1. The counter k is incremented (130). Each uncoded segment U′[k] is xored XOR[k] with the result of encoding E[k-1] (132). E[k] encodes the output of xoring XOR[k] (134), which provides coded output C′[k]. If k is less than n (i.e., the last segment is not xored and encoded) (136), the counter k is incremented (130) and then the xoring and encoding is implemented for the next segment (132, 134).

In a non-limiting example, the last segment U[n] serves as the first segment U′ [1] that is xored with the random set of m bits. In a further non-limiting example, the uncoded segments are chained in reverse order (i.e., U[1]→U′[n], U[2]→>U′[n−1], . . . , U[n]>U′[1]) as shown in FIG. 3. Here the last output byte is computed first, then the computed output byte is chained to the second to the last byte and so on.

It would be appreciated by one of ordinary skill in the art that any ordering is possible as long as it is known to a receiver which decodes the encoded outputs. The method for change of order is not limited by those of FIGS. 3-4. The order may be changed every execution or several executions of chaining the bytes.

In FIGS. 3-4, the initialization vector and the change of order for chaining are combined to vary encoding. It would be appreciated by one of ordinary skill in the art that the chained transform may implement encoding with the change of order for chaining, without the initialization vector such that the first segment U′[1] of the input is encoded E[1] without xoring.

It would be appreciated by one of ordinary skill in the art that the uncoded input may be divided into two or more than three byte segments, and the segment number n may vary. The chained transform modules 10 and 20 may include two or more than three encodings and XORs. The chained transform modules 10 and 20 may include components not illustrated in FIGS. 1 and 3, such as a memory. Each encoding E[k] may be different.

For secure data protection, a mode, such as counter mode (CM), is less desirable since the encoding of a byte depends only on the byte's value and its position. This means that this byte will always be encoded in the same way, and thus an attacker with multiple blocks may be able to detect fixed fields. By contrast, the chained transform uses the initialization vector, chains the output bytes together in a different order, or a combination thereof. Thus the first encoded byte would no longer have a single fixed encoding. The first byte will not always give the same output value and therefore will not always make the same contribution to the encoding selection on the second byte.

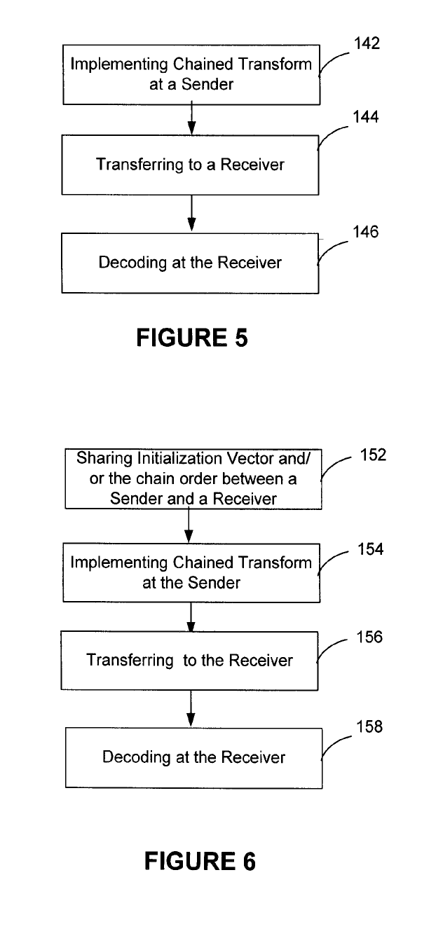

Referring to FIG. 5, in a non-limiting example, the chained transform of FIGS. 1-4 is implemented in a sender (142), and the coded outputs together with the initialization vector are transferred to a receiver (144). The receiver decodes its inputs (146). Here the structured data is transformed by the chained transform and sent to the receiver, which prevents an attacker from intercepting the inputs to the decoder. The initialization vector may be changed every execution or several executions or random timing.

Referring to FIG. 6, in a non-limiting example, the initialization vector and/or the order of the chain is shared with a sender and a receiver (152). The chained transform is implemented at the sender (154), and the coded outputs are transferred to the receiver (156). The receiver decodes the coded outputs (158). Here the structured data is transformed by the chained transform and sent to the receiver, which prevents an attacker from intercepting the inputs to the decoder. In this scenario, the uncoded bytes may be chained in a different order as shown in FIGS. 3-4, in order to prevent the attacker for obtaining a clue for decoding. Although an implied initialization vector may be fixed on each execution, the chained transform can process, for example, the last byte first and then chain it to, for example, the second to last byte, etc. This would work well if the last byte of data tends to have good variability. Any other fixed order of processing the bytes is possible as well.

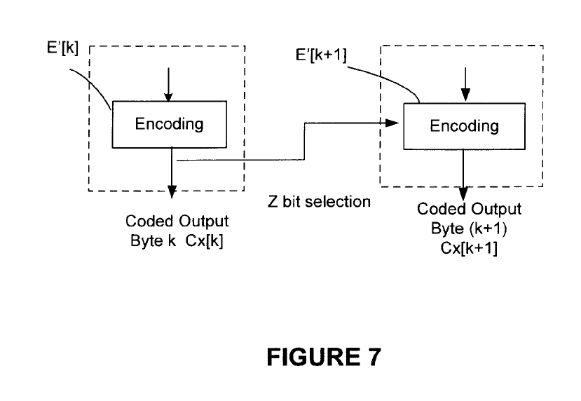

Referring to FIG. 7, a further example of the chained transform is described in detail. In FIG. 7, z bits of the coded output byte varies the encoding of the next uncoded byte. Here z bit of coded output byte Cx[k] from encoding E′[k] is used for choosing one E′[k+1] of different encodings, and E′[k+1] is used for encoding to the next uncoded byte. In one example, the xor operation of FIGS. 1 and 3 is replaced with a z-bit lookup of 2̂ z different encodings, as described below.

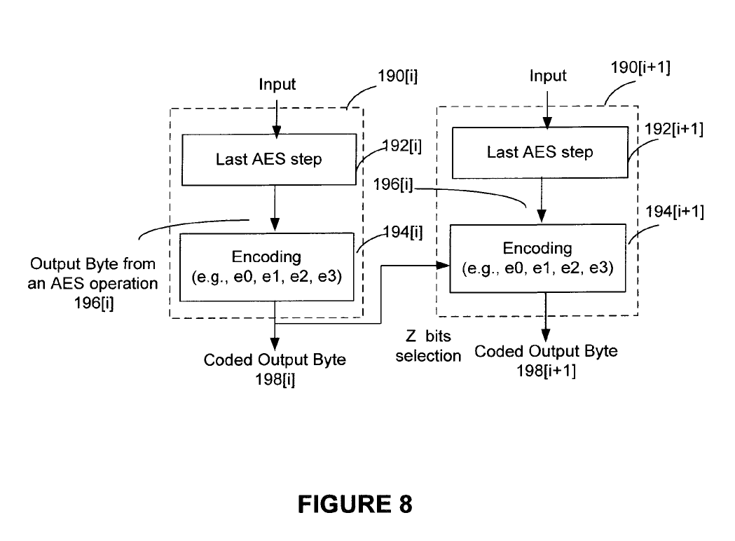

One example of the chained transform shown in FIG. 7 is described with reference to FIG. 8. In FIG. 8, the chained transform is composed with another transform to form a composite transform. In this example, the transform combined with the chained transform is an output encoding implemented together with an Advanced Encryption Standard (AES) operation.

One example of the last set of tables for an AES operation with the chained transform is schematically illustrated in FIG. 8. The (i+1)th table 190[i+1] of the last set of tables combines AES sub-operations 192[i+1] along with an output encoding 194[i+1]. The encoding 194[i+1] for encoding the output uncoded byte 196[i+1] from the AES operation is selected depending on z bits of the ith coded output byte 198[i] or the initialization vector (i.e., i=1). The table 190[i+1] takes an extra z bits that determine how the next output byte is encoded. The table size increases by a factor 2̂z. If the last set of tables takes an extra byte of input (the previous coded byte or initialization vector) it would increase the size of the tables by a factor of 256. Thus the size of the tables with the z bit selection is smaller than that of the byte selection. In one example, the z bit may vary so that the table size is adjusted.

The AES table that produces the first encoded output byte is unchanged. In a non-limiting example, the first table of the last set of tables may have an initialization vector as a set of z bits. In a further example, the first table of the last set of tables may have a single encoding without the initialization vector,

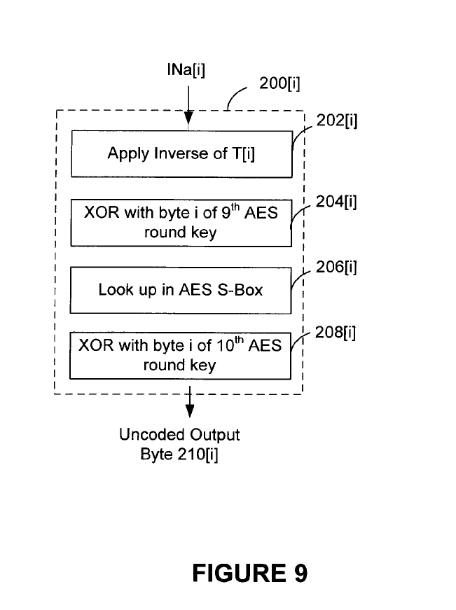

FIG. 9 illustrates an example of AES sub-operations without an output encoding. Input INa[i] to the ith table 200[i] of the last set of tables for the AES operation has some transform T[i]. Here the ith table 200[i] combines the following sequence of operations: applying inverse of T[i] (202[i] of FIG. 9); xoring with byte i of the 9^{th} AES round key (204[i] of FIG. 9); looking up in AES S-box (206[i] of FIG. 9); and xoring with byte i of the 10^{th} AES round key (208[i] of FIG. 9), which provides an uncoded output byte 210[i].

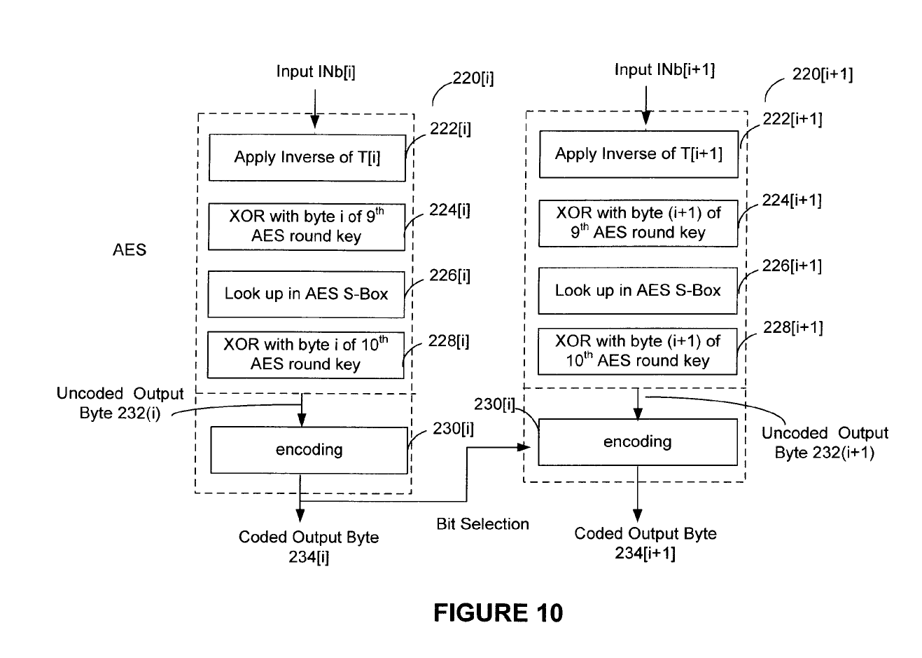

FIG. 10 illustrates an example of the chained transform combined with AES sub-operations. Input INb[i] to the ith table 220[i] of the last set of tables for the AES operation has some transform T[i]. The last set of tables 220[i] (i=1, 2, . . . , 16) combines the following sequence of operations: applying inverse of T[i] (222[i] of FIG. 10); xoring with byte i of the 9^{th} AES round key (224[i] of FIG. 10); looking up in AES S-box (226[i] of FIG. 10); xoring with byte i of the 10^{th} AES round key (228[i] of FIG. 10); and encoding 230[i] of the uncoded output byte 232[i] from 228[i]. The table 220[i+1] takes z bits of the coded output byte 234[i] to determine how the uncoded output byte 232[i+1] is encoded 230[i].

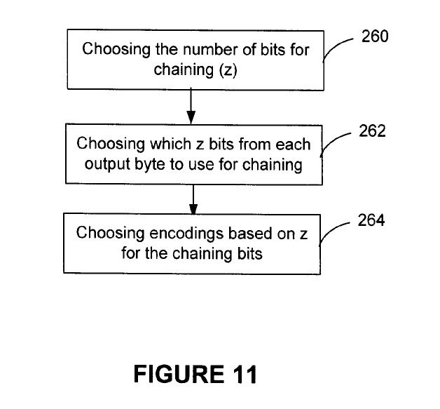

Referring to FIG. 11, the number “z” of bits for chaining is chosen (260) to vary encodings. For example, z=2. Then it is determined which z bits for chaining are chosen from each coded output byte (262). In one example, the bottom 2 bits (z=2) will be chosen from each coded output byte. Based on the number z, 2̂ z (=y) encodings e(1), . . . , e(y) are chosen (264). In one example, 4 (=2̂2) encodings (e0, e1, e2, e3) are chosen. All the subsequent tables takes an extra 2 bits of input from the previous encoded output byte to determine how the uncoded output byte from the AES operation is encoded by selecting one of e0, e1, e2 or e3 based on the selected 2 bits. In this example, z=2 as a trade-off between the number of encodings and increased table size for a AES-based implementation. It would be appreciated by one of ordinary skill in the art that z is not limited to “2” and may be any number.

The four encodings may be common to all 16 bytes or may be different for each byte. The selected encodings are, for example, bijections, which can be randomly selected. The inverse bijections will be implemented at the last stage of data processing (e.g., displaying a video at a receiver) to remove the bijections.

If there are constraints in the later processing, these encodings may be linear or affine mappings over GF(2̂8), concatenated 4 bit arbitrary bijections or a composition of these two. Other possibilities exist as well.

The chained transform may be implement by changing the order of the uncoded bytes. Chaining of bytes for selection of encoding may go in any order (e.g., in reverse order).

The chained transforms described above are applicable for obscuring data flows between secured modules that contain structured data, such as encoded content processed by Digital Rights Management (DRM) clients and content decoders. Examples of data flows between secured modules that contain structured data are disclosed in U.S. Pat. No. 7,350,085, U.S. Pat. No. 6,594,761, U.S. Pat. No. 6,842,862, and U.S. Pat. No. 7,966,499, which are incorporated herein by reference. The chained transformed data may be further computed on by operations disclosed in U.S. Pat. No. 7,350,085, U.S. Pat. No. 6,594,761, U.S. Pat. No. 6,842,862, amd U.S. Pat. No. 7,966,499.

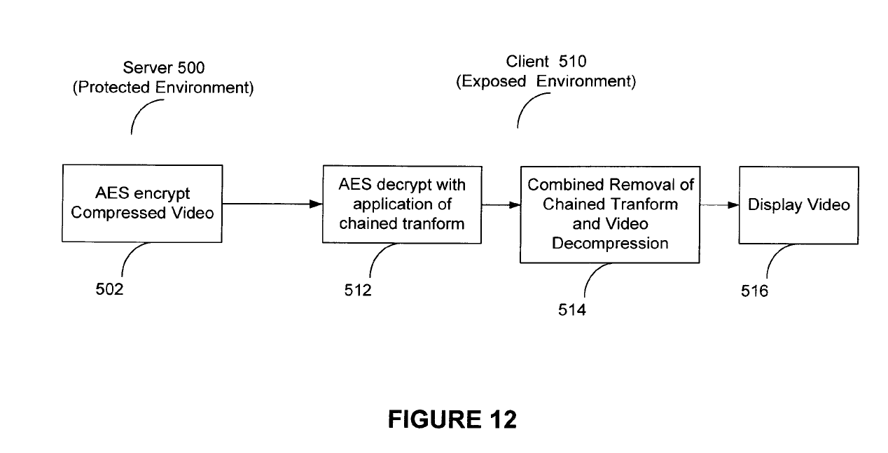

In a non-limiting example, the chained transform may be used to protect compressed video that will be transferred from a sender to a receiver, such that capture of compressed video is prevented as shown in FIG. 12. Here the chained transform is used to protect compressed video. The video is processed by AES encryption and compression (502) at a server 500 in a protected environment, and is transferred to a client 510 in an exposed environment. In the client 510, its input is transformed by AES decryption with the chained transform (512), which prevents an attacker from intercepting the decryption result. The output of the decryption with the chained transform is provided to a decoder where the client 510 implements a combination of a removal of the chained transform and decompresses (514) so that video is displayed (516).

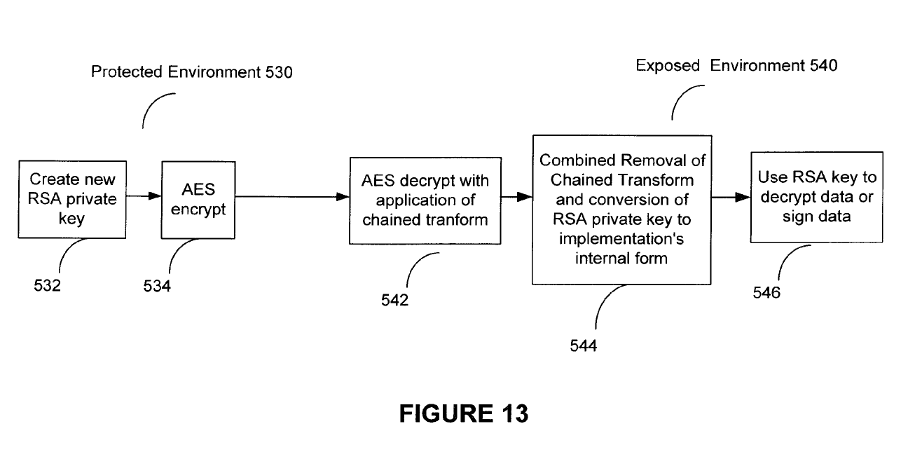

In another non-limiting example, the chained transform may be used for dynamic RSA key loading where the RSA private key is updated in a white-box RSA implementation as shown in FIG. 13. Here the chained transform is used for updating the RSA private key in a white-box protected RSA implementation. A new RSA private key is created (532) and AES encrypted (534) in a protected environment 530. In an exposed environment 540, the encrypted RSA private key is transformed by AES decryption with the chained transform (542), which prevents an attacker from intercepting the decryption result. Then the system implements a combination of a removal of the chained transform and conversion of RSA private key to the implementation's internal form (544). The RSA private key is provided (546).

In both cases of FIGS. 12 and 13, the chained transforms described above can be added as one of the output encoding choices for AES decryption in CBC mode.

It will be appreciated by one of ordinary skill in the art that each of the server 500 and the protected environment 530 in FIGS. 12-13 has a processor for implementing the chained transform and/or the variant of the chained transform, and a memory storing instructions for implementing these transforms. It will be appreciated by one of ordinary skill in the art that each of the client 510 and the exposed environment 540 in FIGS. 12-13 has a processor for implementing reversing (decoding) the chained transform and/or the variant of the chained transform, and a memory storing instructions for implementing these transforms.

The embodiments described herein may include one or more elements or components, not illustrated in the drawings. The embodiments may be described with the limited number of elements in a certain topology by way of example only. Each element may include a structure to perform certain operations. Each element may be implemented as hardware, software, or any combination thereof. The data structures and software codes, either in its entirety or a part thereof, may be stored in a computer readable medium, which may be any device or medium that can store code and/or data for use by a computer system. Further, a computer data signal representing the software code which may be embedded in a carrier wave may be transmitted via a communication network.

One or more currently preferred embodiments have been described by way of example. It will be apparent to persons skilled in the art that a number of variations and modifications can be made without departing from the scope of the invention as defined in the claims.

1. A method for secure data protection, comprising:
carrying out a transform on structured data comprising a fixed data field for implementing an application, the structured data having n segments, each having m bits, including:
encoding each of the n segments subsequently to provide n coded segments, including:
encoding each of the (n−1) segments depending on a previous segment value; and
changing at least one of the n encodings to the n segments such that the fixed data field of a first structured data is encoded differently from the fixed data field of a second structured data, and the transformed first structure data and the transformed second structure data are further processed in the same operation for implementing the application.

2. A method according to claim 1, wherein the changing at least one of the n encodings comprises:
changing an input to a first encoding on the first segment of the structured data, based on a combination of the first segment and an initialization vector.

3. A method according to claim 2, wherein the changing an input comprises:
performing an xor operation on first segment of the structured data with the initialization vector to provide the input.

4. A method according to claim 3, wherein the encoding each of the (n−1) segments comprises:
encoding an output derived by performing an xor operation on the kth segment with the (k−1) coded segment.

5. A method according to claim 1, wherein the changing at least one of the n encodings comprises:
changing the order of the n segments such that the first segment of the structured data is encoded after at least one of the (n−1) segments is encoded.

6. A method according to claim 5, wherein the changing comprises:
chaining the n segments in a reverse order such that the last segment of the structure data is encoded first.

7. A method according to claim 1, wherein the changing at least one of the n encodings comprises:
selecting each of the (n−1) encodings to the (n−1) segments based on a part of the previous coded segment.

8. A method according to claim 7, wherein each segment is a byte, and wherein the selecting comprises selecting each of (n−1) encodings to the (n−1) bytes based on a z bit of the previous coded byte (8>z>1).

9. A method according to claim 1, wherein the segment is formed by a byte, and each byte is encoded on a byte by byte basis.

10. A method according to claim 1, wherein the fixed data filed is a header of the structured data.

11. A method according to claim 10, wherein the structured data comprises video stream and/or RSA private key.

12. A method according to claim 1, wherein the structured data is transformed by carrying out AES encryption with the transform.

13. A method according to claim 12, comprising:
decoding the transformed structure data.

14. A method according to claim 12, wherein the segment is a byte, and comprising:
building a table with a 8 bit look up for the AES operation on the structured data and a z bit lookup for selecting 2̂ z different encoding.

15. A method according to claim 1, comprising:
decrypting the structured data with the transform.

16. A computer readable storage medium storing computer instructions which, when executed one or more processors, causing a system having at least one of the one or more processors to perform the method comprising:
carrying out a transform on structured data comprising a fixed data field for implementing an application, the structured data having n segments, each having m bits, including:
encoding each of the n segments subsequently to provide n coded segments, including:
encoding each of the (n−1) segments depending on a previous segment value; and
changing at least one of the n encodings to the n segments such that the fixed data field of a first structured data is encoded differently from the fixed data field of a second structured data, and the transformed first structure data and the transformed second structure data are further processed in the same operation for implementing the application.

17. A system for secure data protection, comprising:
at least one process or a processor; and
one or more memories operatively coupled to at least one of the one or more processors and storing computer instructions which, when executed at least one of the one or more processors, causes the system to:
carry out a transform on structured data comprising a fixed data field for implementing an application, the structured data having n segments, each having m bits, including:
encode each of the n segments subsequently to provide n coded segments, including:
encode each of the (n−1) segments depending on a previous segment value; and
change at least one of the n encodings to the n segments such that the fixed data field of a first structured data is encoded differently from the fixed data field of a second structured data, and the transformed first structure data and the transformed second structure data are further
